(19) United States
(12) Patent Application Publication
(10) Pub. No.: US 2024/0311223 A1
(43) Pub. Date: Sep. 19, 2024

(54) Log Clustering for Guided Root Cause Analysis

(71) Applicant: ServiceNow, Inc., Santa Clara, CA (US)

(72) Inventor: Eugene Aaron Shtilkind, San Diego, CA (US)

(21) Appl. No.: 18/123,120

(22) Filed: Mar. 17, 2023

(51) Int. Cl. G06F 11/07

(52) U.S. Cl. CPC G06F 11/079; G06F 11/0769

(57) ABSTRACT

An example embodiment may involve: obtaining a plurality of incident logs, each incident log including a respective sequence of events; classifying each of the respective sequences of events into a respective event class; determining cluster spaces respectively associated with the respective event classes; determining, from the plurality of incident logs, relationships between at least some clusters in the cluster spaces; and possibly based on the clusters and the relationships, suggesting one or more investigatory steps to determine a root cause of a symptom found in a subsequent incident log, wherein the symptom describes a problem experienced by a user.

### BACKGROUND

Root cause analysis and defect resolution in computing systems is a critical task that is often poorly performed. As a consequence, a defect in a network of computing devices, an individual computing device, and/or software applications executing thereon can result in these resources remaining in a non-functional or limited-functionality state for periods of time before the root cause of the defect is determined. Such delays have a deleterious impact on device, network, application performance, whether making the services that they provide slow, unreliable, or completely unavailable.

### SUMMARY

These and other technical problems may be overcome through use of the embodiments herein. In particular, these embodiments may involve preprocessing a corpus of logs to identify the problems, investigatory steps, root cause determinations, and ultimate problem resolutions therein. Each log may include text representing user-provided, agent-provided, and/or automatically-generated descriptions of the problem, the investigatory steps taken to determine the nature of the problem, the root cause of the problem, and how the problem was resolved.

With thousands, hundreds of thousands, millions, or more of these logs stored in a database, they can be processed and used to train machine-learning models. These models may include a classifier that categories events in the logs into one or more pre-defined classes, as well as a clustering model that groups similar symptoms, investigatory steps, root cause determinations, and resolutions found in the classified events into respective cluster spaces. Probabilistic relationships between these clusters can be found. For instance, given a symptom, different investigatory steps may have different likelihoods of leading to a successful identification of a root cause.

This allows automated, semi-automated, or agent-based investigations of similar problems in the future to progress according to these likelihoods. In other words, once a new problem is identified, a series of investigatory steps may be determined. By carrying out these steps in a given order, the time to resolution of the problem may be minimized or at least reduced. As a consequence, computing devices, systems, networks, and applications suffer less down time and their overall reliability is improved.

Accordingly, a first example embodiment may involve: obtaining a plurality of incident logs, each incident log including a respective sequence of events; classifying each of the respective sequences of events into a respective event class; determining cluster spaces respectively associated with the respective event classes; determining, from the plurality of incident logs, relationships between at least some clusters in the cluster spaces; and based on the clusters and the relationships, suggesting one or more investigatory steps to determine a root cause of a symptom found in a subsequent incident log, wherein the symptom describes a problem experienced by a user.

A second example embodiment may involve: obtaining an incident log that contains an event indicative of a symptom, wherein the symptom describes a problem experienced by a user; performing a comparison between the event and a plurality of symptom clusters within a symptom cluster space, wherein the plurality of symptom clusters represents symptoms associated with events in a plurality of previously-obtained incident logs; based on the comparison, identifying a symptom cluster from the symptom cluster space; based on the symptom cluster, selecting an investigatory step cluster from an investigatory step cluster space, wherein the investigatory step cluster is associated with one or more root cause clusters from a root cause cluster space, wherein the investigatory step cluster space was derived from the events in the plurality of previously-obtained incident logs, and wherein the root cause cluster space is also associated with the events in the plurality of previously-obtained incident logs; and determining that an investigatory step from the investigatory step cluster has led to identification of a root cause of the symptom, the root cause being from one of the root cause clusters.

A third example embodiment may involve a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6A depicts a sequence of events from an incident log, in accordance with example embodiments.

FIG. 6B depicts a sequence of events from another incident log, in accordance with example embodiments.

FIG. 7A is a flow chart representing a training phase, in accordance with example embodiments.

FIG. 7B is a flow chart representing a prediction phase, in accordance with example embodiments.

FIG. 8A depicts a cluster space, in accordance with example embodiments.

FIG. 8B depicts probabilistic relationships between clusters, in accordance with example embodiments.

FIG. 9A is a flow chart, in accordance with example embodiments.

FIG. 9B is another flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

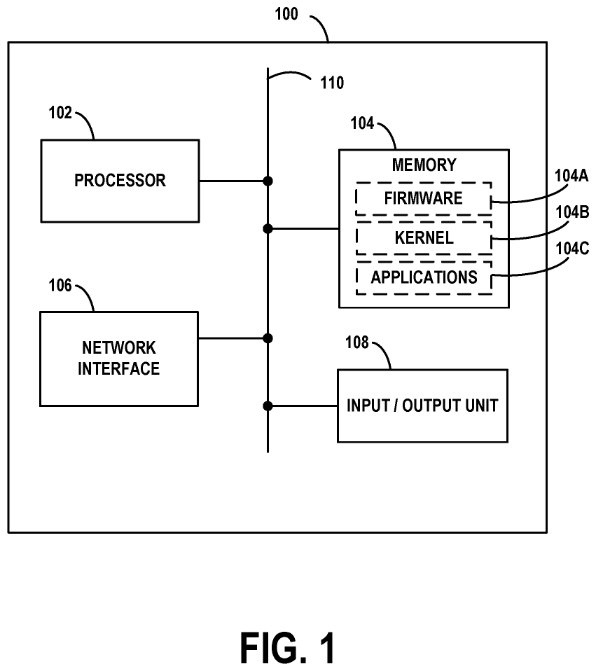

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

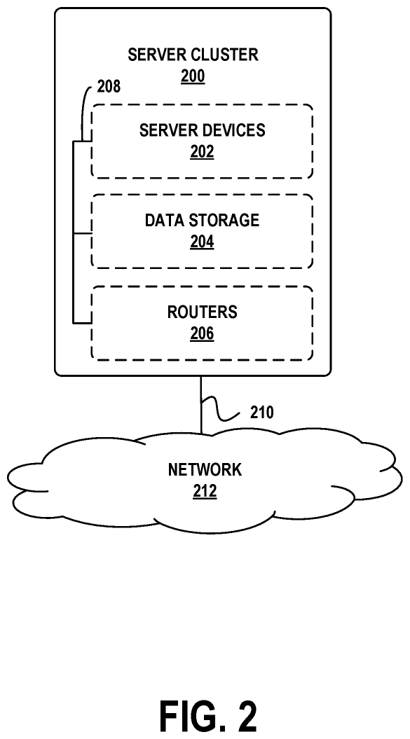

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

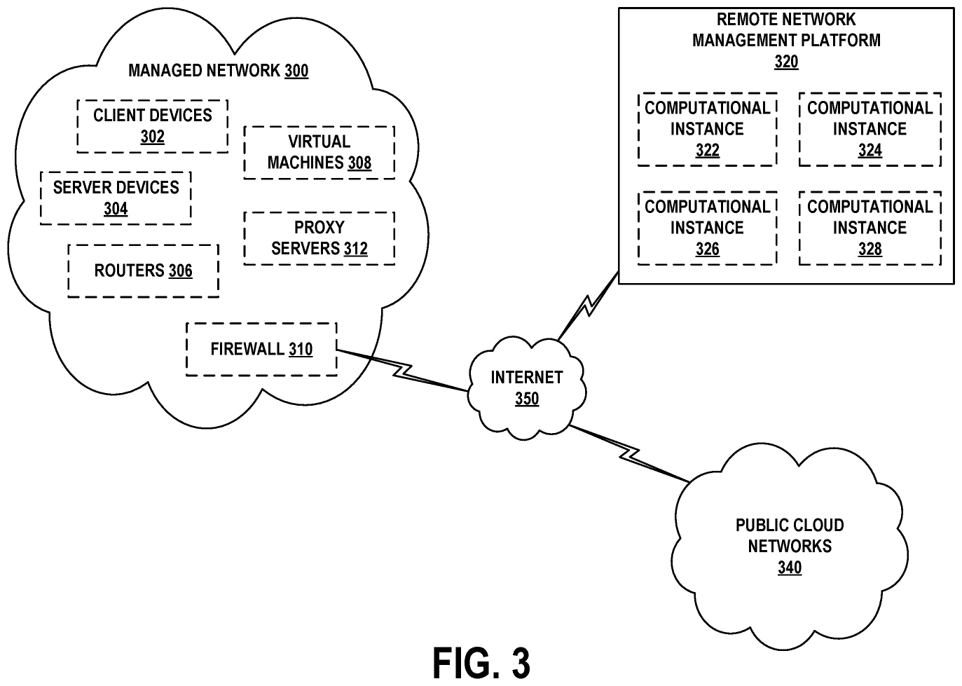

FIG. 3 depicts a remote network management architecture, in accordance with example embodiments. This architecture includes three main components-managed network 300, remote network management platform 320, and public cloud networks 340-all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

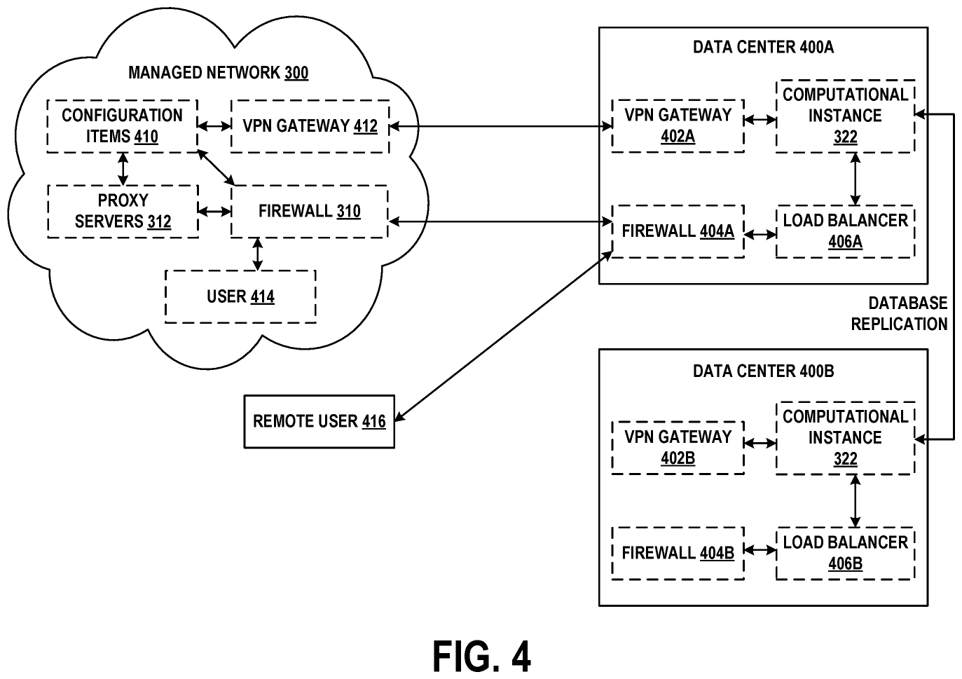

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

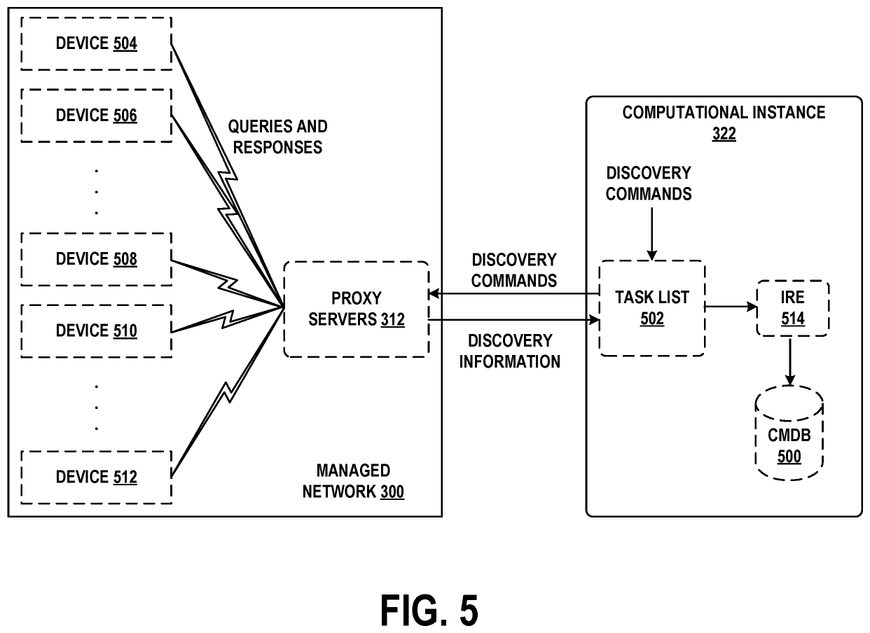

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®—specific probes may be used. Likewise, if a device was classified as WINDOWS® 10, as a set of WINDOWS®-10—specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices-for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Incident Reporting and Resolution

Given the large networks described herein, it is inevitable that—at any given time—some components (e.g., computing devices, systems, applications, services, and/or networks) are not operating properly. These defects may be due to misconfigurations, incompatibilities, software bugs, hardware failures, or a mismatch between resource supply and demand (e.g., a device runs out of RAM or disk storage). Such defects cause slowness, unreliability, and/or outages of services that users depend upon. To be clear, these are technical problems, in that one or more hardware or software components are not performing as designed, resulting in a deleterious impact to systems as well as users.

Defects such as these may be referred to a “problems” and reported, investigated, and resolved by way of an incident log (sometimes referred to as an “incident”, an “IT trouble ticket”, or a “ticket”). An incident log is a document or record used to report and track issues related to computer systems, software, and network infrastructure. These incident logs are typically created by users who are experiencing technical difficulties, and are then assigned to virtual agents (e.g., chatbots) and/or human agents for resolution. An incident log will typically include information such as the user's contact information (e.g., email address and phone number), a description of the problem written by the user, the date and time that the incident was created, and any relevant system details (e.g., the user's client device and/or local network). As the agent works to resolve the problem, additional information may be added to the incident log, such as investigatory steps taken, the status of the problem, and so on.

While the embodiments herein are described in the context of incident logs, these embodiments may be used with other types of logs as well. Thus, the examples discussed below are for purposes of illustration and not limiting.

Typically, the incident log takes the form of one or more associated text files or database entries with timestamped records of each action taken by the user and the agent, as well as any interactions between the user and the agent. This textual content may include the user's problem description, dialogs between the user and the agent, the agent's investigation notes (which may include the output of diagnostic steps taken by the agent), a description of the root cause of the problem (if applicable), and a description of the resolution steps taken to address (fix) the problem.

When a problem is reported, its root cause can be unclear. An initial description of problem as it appears in an incident log might be vague. For example, a user might create an incident log with a problem description of “I cannot get on the network.” The agent investigating this problem would likely then determine what kind of client device the user is utilizing (e.g., laptop, mobile phone, or tablet), the operating system being used on this device, and the network that the user is trying to access.

Thus, the agent might ask the user a series of questions (e.g., by phone, email, and/or chat session) so that the user's operational environment has been identified. Then, the agent might ask the user to carry out one or more steps on their device, such as resetting an interface, changing configuration settings, or rebooting. The agent might also carry out a number of steps, such as remotely accessing a router or Wifi access point near the user to check the status of these devices and the network which they are part of. Some of the user's or agent's activities could involve executing diagnostic tools (e.g., apps or scripts) that might provide further insight into the problem.

Eventually, the agent may identify a root cause of the problem. For instance, suppose that the user is unable to use their local Wifi access point. Possible root causes include: radio interference from other devices, distance to the access point, incorrect Wifi settings on the user's client device, out of date firmware installed on the access point, hardware failure of the access point, an overloaded Wifi network or downstream network, and so on. It may take the agent a potentially large number of investigative steps to determine which of these is the actual root cause.

As noted, the result of each investigatory step, whether it successfully determines the root cause or not, may be recorded in the incident log. Output from any diagnostic tools may also be recorded as well.

Once the root cause is identified, a resolution is usually apparent. For example, if the root cause is that the user is attempting to connect to a Wifi access point that is too far away (and thus has low signal strength in the location of the user), the resolution might be for the user to move closer to the access point or connect to a closer access point. If the root cause is that the access point is low on memory (perhaps due to a memory leak defect in its firmware), the resolution might be for the agent to reboot the access point. Regardless, the actions taken by any party to resolve the problem may also be recorded in the incident log.

Once the user is satisfied with the resolution or is otherwise no longer inhibited by the problem, the incident log may be closed. But closed incident logs remain in a database for purposes of auditing as well as for assistance with resolution of similar future problems. Thus, the database for even a modestly sized organization may grow over time to include tens of thousands of incident logs, or more.

Despite the general context of the embodiments herein being that of an enterprise network with potentially many users, the technologies described may also be applicable to smaller environments with fewer users. For example, problems experienced by residential, home office, or small office users could also be addressed. Thus, the applicability of these embodiments is not limited to the environments described herein.

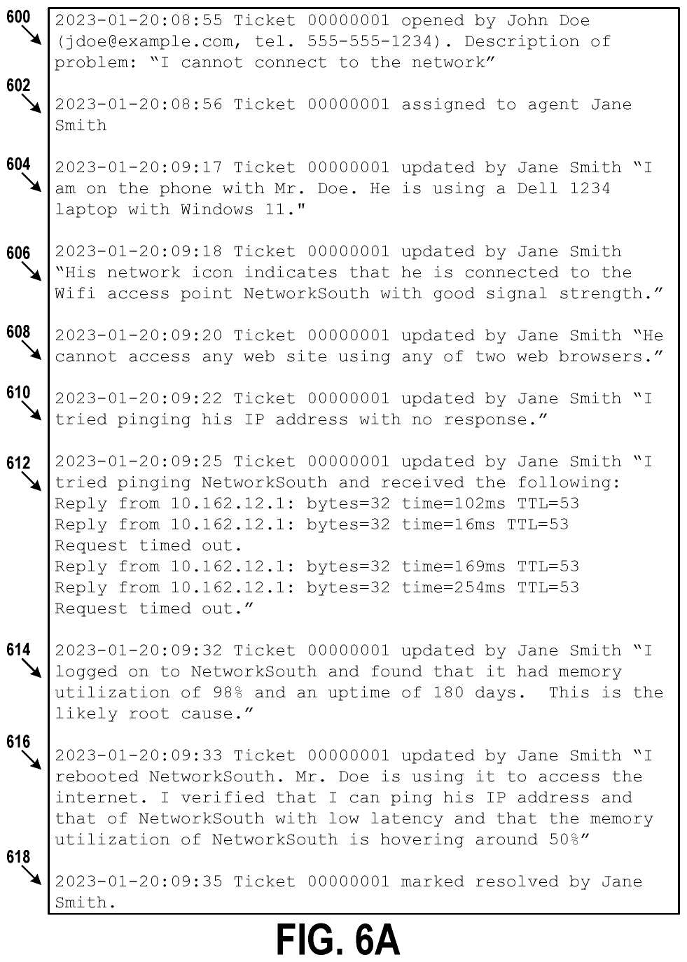

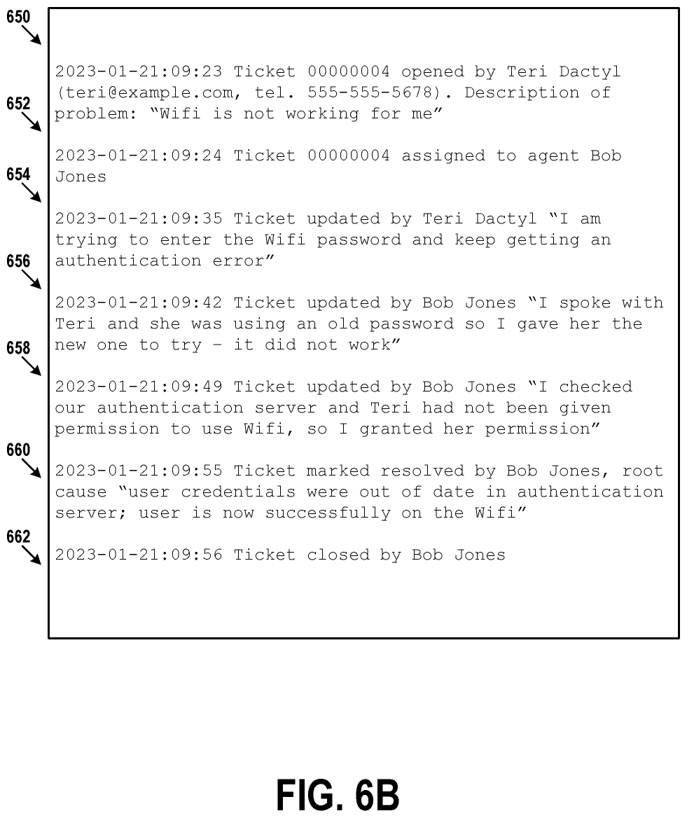

FIG. 6A depicts an example excerpt from an incident log containing a sequence of events. This sequence focuses on a problem reported by a user, investigatory steps taken by the agent, determination of root cause, and subsequent resolution of the problem. Each event has a timestamp, an actor (the person or agent who created the event), and text descripting the event.

Event 600 involves opening of the incident log (ticket 0000001) by user John Doe. This event includes the user's contact information and a brief description of the problem that is being experienced. In this case, the reported symptom of the problem is that the user cannot connect to a network.

Event 602 involves the incident log being assigned to agent Jane Smith.

Event 604 involves an investigatory step of the agent conferring with the user and determining the user's laptop brand and model, as well as its operating system.

Event 606 involves an investigatory step of the agent determining that the user's laptop is connected to a Wifi access point with good signal strength.

Event 608 involves an investigatory step of the agent determining that the user cannot access any web site regardless of web browser used.

Event 610 involves an investigatory step of the agent conducting a “ping” transaction to the user's laptop and receiving no response. Ping is an application that transmits packets from one computer to another and receives corresponding responses along with an estimate of latency between the computers for each.

Event 612 involves an investigatory step of the agent conducting a “ping” transaction to the Wifi access point and determining that the ping times are both erratic and high, and that there is packet loss between the agent's computer and the Wifi access point.

Event 614 involves identification of the root cause. The agent determines it to be the Wifi access point having memory utilization that is very high (98%) and that it has not been rebooted for about 6 months.

Event 616 involves the resolution of the problem. The agent reboots the Wifi access point, determines that the user can now access the network, and that the Wifi access point is performing as expected.

Event 618 involves that agent marking the incident log as resolved.

Notably, event 600 describes the symptom of the problem that the user is experiencing. Events 604, 606, 608, 610, and 612 describe investigatory steps. Event 614 describes the root cause of the problem, and event 616 describes the resolution to the problem. This sequence of events is typical, in the sense that there are multiple investigatory steps taken before the root cause is determined. Events 602 and 618 are incident log management steps that are not strictly relevant to the problem, the investigation, the root cause, or the resolution.

FIG. 6B depicts another example excerpt from an incident log.

Event 650 involves opening of the incident log (ticket 0000004) by user Teri Dactyl. This event includes the user's contact information and a brief description of the problem that is being experienced. In this case, the reported symptom of the problem is that the user cannot access the Wifi.

Event 652 involves the incident log being assigned to agent Bob Jones.

Event 654 involves the incident log being updated to add more detail about the symptoms of the problem.

Event 656 involves an investigatory step of the agent providing the user with an updated password, but finding that this new password also did not work.

Event 658 involves an investigatory step of the agent determining that an authentication server did not permit the user to use the Wifi, and then granting this permission.

Event 660 involves identification of the root cause and resolution of the problem. The agent determines that the user's credentials were out of date in the authentication server and that updating them to grant access resulted in the user being able to use the Wifi. This event also includes the incident log being marked as resolved.

Event 662 involves the incident log being closed.

Notably, events 650 and 654 describe the symptom of the problem that the user is experiencing. Events 656 and 658 describe investigatory steps. Event 660 describes the root cause of the problem as well as the resolution to the problem. Events 652 and 662 are incident log management steps that are not strictly relevant to the problem, the investigation, the root cause, or the resolution. Unlike the sequence of events in FIG. 6A, this sequence of events has two separate events that describe the symptom and one event that describes both the root cause and resolution.

Even just these two examples demonstrate the various ways in which symptoms, investigatory steps, root cause determinations, and resolutions can be carried out and represented in incident log. Nonetheless, other arrangements of this content within incident logs may occur. Thus, the examples of FIG. 6A and 6B are for purposes of illustration and not limiting.

There is a wealth of information in incident logs. And, as noted above, many organizations have generate a large number of such logs (e.g., dozens, hundreds, or thousands) each week, month, quarter, and so on. In combination, the incident logs can contain an organization's memory-a record of problems that the organization has experienced and how these problems were resolved-that can be valuable when attempting to solve similar problems in the future.

Thus, an organization can benefit from being able to mine its incident logs in order to determine investigatory steps that are most likely to resolve a given problem in the fastest and most efficient manner. Agents can then use or be guided by this insight when attempting to determine root cause and resolve new problems. One potentially important observation is that not all investigatory steps are equally likely to lead to a root cause determination.

For instance, in the case of the incident log of FIG. 6A, obtaining the brand, model, and operating system of the users laptop in event 604 did not contributed to the root cause determination. In contrast, pinging the Wifi access point in event 612 and remotely accessing the access point to determine its memory utilization in event 614 directly led to ascertainment of the root cause and the resolution of the problem.

The embodiments herein provide techniques for processing incident logs using various types of machine-learning-based natural language processing tools. These techniques result in a summarization and characterization of past incident logs that can be used to guide how agents proceed while addressing similar incidents encountered in the future. First, a corpus of existing incident logs are used to train an incident log model. Then, this model is used to predict investigatory steps that are most likely to lead to root cause determination for subsequent incidents.

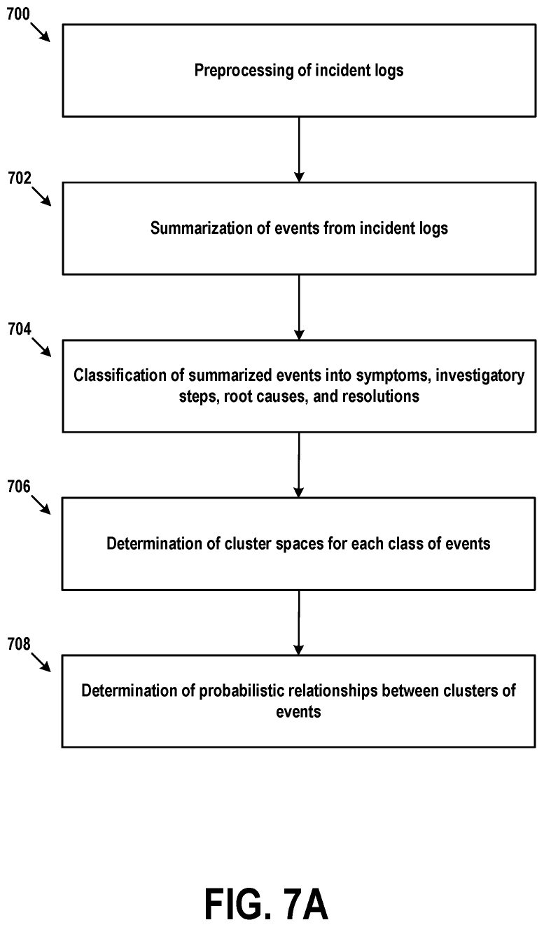

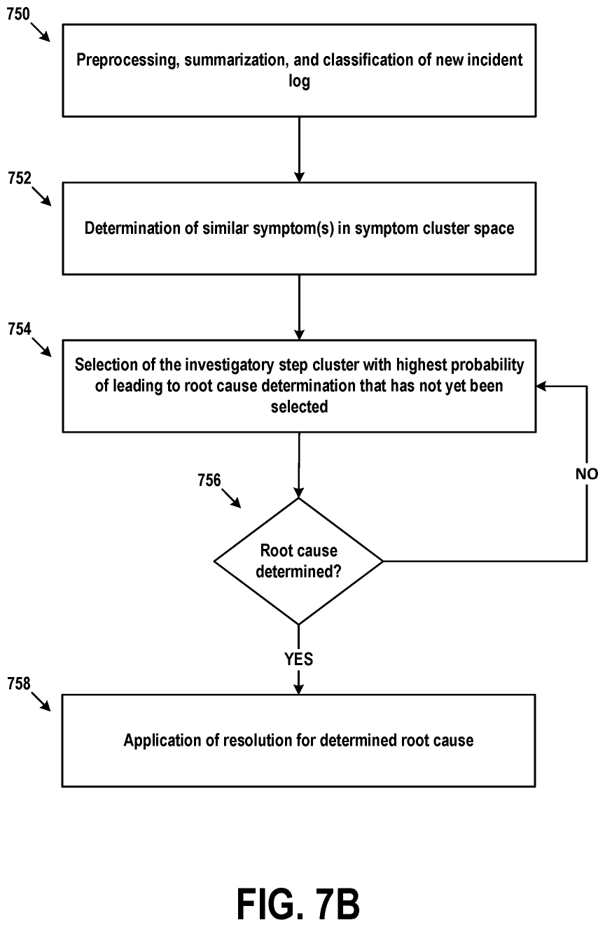

FIG. 7A depicts the training phase. Each of these blocks will be defined in more detail below.

Block 700 involves preprocessing the incident logs to prepare them to be used for training the model. Block 702 involves summarization of events from the incident logs to obtain shorter yet still relevant textual representations thereof. Block 704 involves classification of the summarized events into symptoms, investigatory steps, root causes, and resolutions. Block 706 involves determination of cluster spaces for each class of events. Block 708 involves determination of probabilistic relationships between clusters of events. These probabilistic relationships provide likelihoods that any particular investigatory step is going to result in determination of root cause of a given problem.

FIG. 7B depicts the prediction phase. Each of these blocks will be defined in more detail below.

Block 750 involves preprocessing, summarization, and/or classification of a new incident log to prepare it to be used with the model. Block 752 involves determination, from the symptom cluster space, of one or more symptoms similar to that of the new incident log. Block 754 involves selection, from the investigatory step cluster space, of the investigatory step with the highest probability of leading to root cause determination. Since block 754 may be carried out for more than one investigatory step, only investigatory steps not already selected are considered. Block 756 involves deciding whether root cause has been determined based on the selected investigatory step. If not, then control returns to block 754. If this is the case, then control passes to block 758. Block 758 may involve application of the resolution for the determine root cause.

These embodiments provide a technical solution to a technical problem. One technical problem being solved is how to rapidly resolve problems with a computing device, system, and/or a network. In practice, such problems are important to resolve quickly because outages have a deleterious impact on the performance of such devices, systems, and networks, causing them to perform below specification or expectations. As a consequence, the services provided may be unreliable or slow, if they work at all.

In the prior art, individual agents determined an ordering of investigatory steps either based on a pre-establish script or their own experience and knowledge. However, these scripted and ad-hoc techniques do not always lead to a resolution, much less in a reasonable period of time. Moreover, the prior art relies on subjective decisions and experiences of individual agents, which leads to wildly varying outcomes from instance to instance. Thus, prior art techniques did little if anything to address rapid resolution of device, system, or network performance degradations.

The embodiments herein overcome these limitations by using incident logs already available to an organization to speed the rate at which new problems are resolved. In this manner, problem resolution can be accomplished in a more rapid, accurate, and robust fashion. This results in several advantages. First, there is no need to develop dozens of scripts for agents when presented with various types of symptoms. Second, these techniques do not rely on the individual proclivities and biases of agents, and instead employ an object process for root cause determination. Third, the embodiments result in less downtime due to degradation and outages of computing device, systems, and networks, allowing the services provided to be accessible with a much higher degree of reliability. Other technical improvements may also flow from these embodiments, and other technical problems may be solved.

### A. Training Phase

This subsection provides a detailed disclosure of the blocks associated with the training phase. Nonetheless, more or fewer blocks of the same or a different character may be used. For example, the preprocessing and summarization blocks can be omitted in some embodiments.

### 1. Preprocessing of Incident Logs

Prior to the beginning of training per-se, the corpus of incident logs may be preprocessed. This can involve any type of normalization or outlier removal, for instance. In some cases, this could involve removing boilerplate or form text from the incident logs. An example of boilerplate or form text could be content automatically added to some or all incident log events, such as “This incident has been queued for consideration by an agent. The agent will contact you if they have any questions during the investigation of your incident.” Since such text is common across incidents and is therefore not useful for root cause determination, it can safely be removed in order to focus the model on remaining content that may be more predictive of root causes. Other types of preprocessing may include removal of punctuation and/or stop words, stemming, lemmatization, and so on. In some cases, preprocessing steps could replace names of users and agents with generic terms, such as “user” and “agent”, respectively.

For example, a preprocessed version of event 616 might be “rebooted NetworkSouth user is using it to access the internet verified can ping his IP address and that of NetworkSouth with low latency and that the memory utilization of NetworkSouth is around 50%”.

### 2. Summarization of Events

After any processing, each event (preprocessed or not) in the corpus may be transformed or summarized. Various techniques may be used to carry out this block, such as extractive or abstractive summarization. Extractive summarization involves selecting the most relevant sentences or phrases from an event and assembling them into a shorter version. Abstractive summarization involves creating a shorter version of the event by generating new sentences that capture the main semantic meaning of the event.

For example, a summarized version of the preprocessed event 616 might be “rebooted NetworkSouth and verified internet access; IP address and that of NetworkSouth have low ping latency; memory utilization of NetworkSouth is 50%”.

### 3. Classification of Events

After summarization, each event is classified into one or more classes. These classes may be symptoms of a problem, investigatory steps, root cause determination, and resolution of a problem. In many cases, each event will be placed into exactly one of these classes. However, it is possible that some events might contain content related to more than one class and thus be classified into two or more classes.

Various types of pre-trained classifiers may be used to perform this classification. For instance, a naïve Bayes, support vector machine, decision tree, random forest, or neural network classifier could be trained on a set of events with labeled ground-truth classifications. This could involve manually labeling a large number of events and then training such a classification model to predict classes of new events based on their textual content. For example, summarized version of the event 616 might be classified into the investigatory step class based on the classifier being trained with similar types of events representing investigatory steps.

In some cases, additional heuristics may be used to enhance or otherwise carry out classifications, such as: initially assuming all events with text from users are related to symptoms of a problem, and/or using the terms “root cause” and “resolution” to place events into those respective classes. It is possible that some classifiers may have a fifth class that is a default or catch-all class in which events that cannot be classified into one of the four classes above are placed. Events relating to administrative steps, such as events 602 and 618, may be placed into this class.

### 4. Determination of Cluster Spaces

The events within each class of event may then be clustered. In other words, there may be one set of clusters for class of events (e.g., symptoms, investigatory steps, root causes, and resolutions). This clustering may be performed independently or semi-independently for each class. The per-class clustering process may include feature selection and then the actual clustering. In the embodiments shown herein, the clustering is unsupervised but some form of supervision may be possible.

Feature selection involves determining measurable qualities within the text of each class to be used as the basis of clustering. These qualities may relate to word choice, word frequency, word length, word meaning, sentence sentiment, or some other feature. Ultimately, each of these features may be mapped to one or more dimensions. Thus, the combination of features form a multidimensional vector (typically of numeric values) for each event in a class.

The actual clustering may use various techniques, such as k-means (partitioning the events into a predefined number of clusters based on their vectors, where each event is assigned to the cluster with the nearest mean value), hierarchical modeling (building a tree-like structure of clusters, where events are grouped together based on the similarity of their vectors), topic modeling (identifying the underlying topics or themes in the events based on word distribution, for example, and grouping the events into clusters accordingly), and/or spectral modeling (projecting the text of the events into a high-dimensional space and then identifying clusters based on the similarity between events in that space).

To further illustrate clustering, word vector modeling is an example of spectral modeling in which a neural network is trained to assign each word in the events into a vector representation based on the contextual words with which it frequently co-occurs. Once vectors are established for each word, vector arithmetic (e.g., averaging of some form) can be used on the words within an event to represent the contextual meaning of the event as a whole. Other techniques such as paragraph vectors, bidirectional encoder representations from transformers (BERT), or various types of large language models may be used to carry out this aspect.

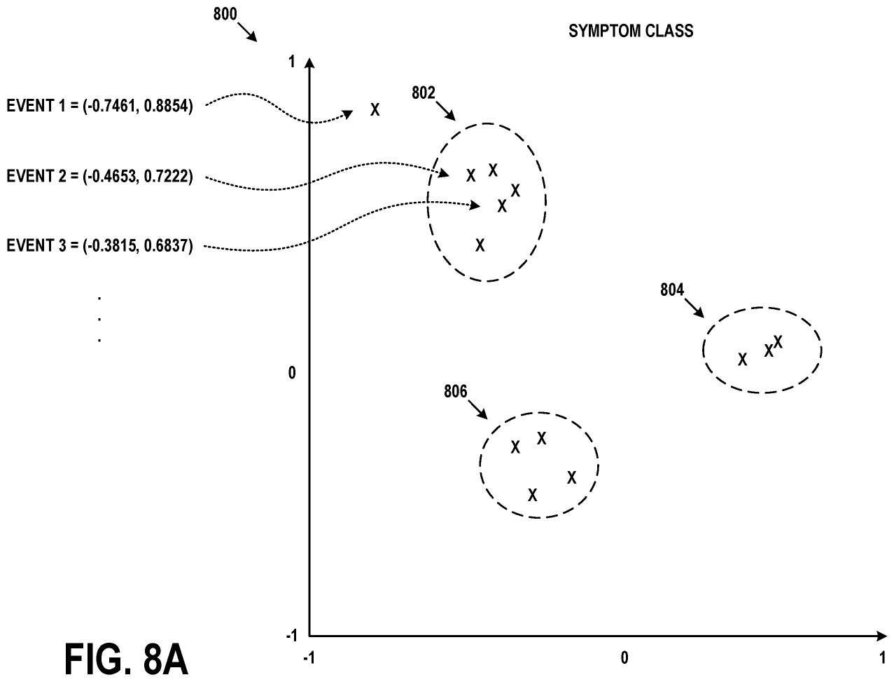

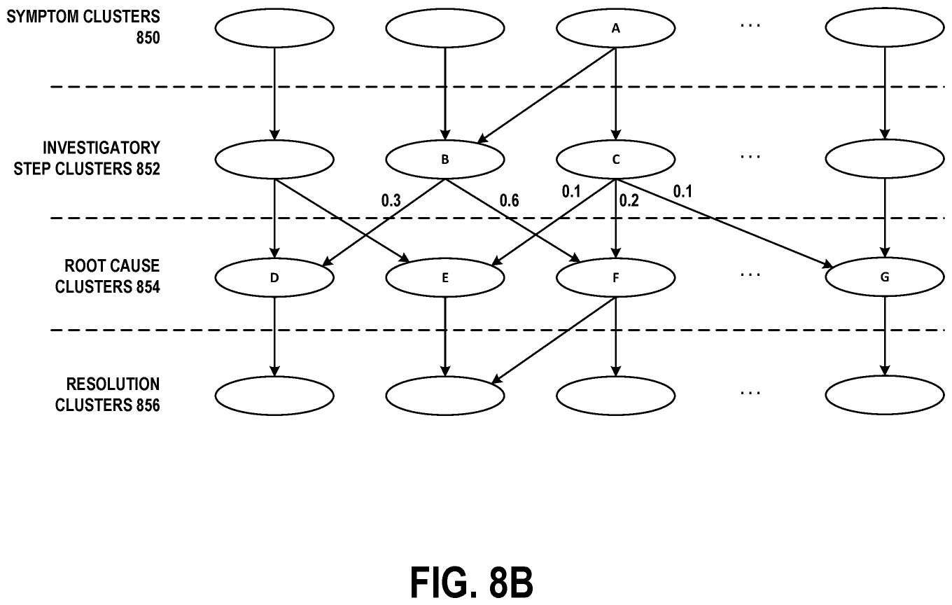

FIG. 8A depicts an example of the clustering process. Here, each event is mapped into a two-dimensional cluster space 800 for purposes of illustration. In various embodiments, larger cluster spaces (e.g., n-spaces) may be used. As noted in FIG. 8, cluster space 800 is for the symptom class. Separate cluster spaces (not shown) may be used for other classes (e.g., investigatory steps, roots causes, and/or resolutions).

Vectors for events 1, 2, and 3 are provided. Particularly, the feature selection process has determined that event 1 has a vector of (−0.7461, 0.8854), event 2 has a vector of (−0.4653, 0.7222), and event 3 has a vector of (-0.3815, 0.6837). Each of these events are represented by an X in cluster space 800. Similarly, other events for which vectors do not explicitly appear in FIG. 8 are also represented by X's in cluster space 800.

Once all of the events within a class are projected into a vector and those vectors are mapped onto cluster space, a clustering technique can be used to associate groups of nearby events into clusters. A goal of this n-dimensional clustering is to group events together based on their proximity to one another in the cluster space. Such a technique may operate by first initializing a set of centroids-points that represent the centers of clusters. The technique may then iteratively assign each data point to the nearest centroid, and update the centroid to be the mean of all the data points assigned to it. This process continues until the centroids converge and the clusters stabilize. At the culmination, each centroid may be, for example, the point that minimizes the sum of the squared distances between all the points in the cluster and the centroid itself. In some cases, the clustering technique may produce one or more residual points that do not belong to any cluster. Residual points can occur when the data set is noisy.

FIG. 8A depicts three clusters and one residual point. Cluster 802 includes events 2 and 3, while clusters 804 and 806 include other events. Event 1 is a residual that is not a member of any cluster. Since the clustering occurs on the basis of the semantic content of the events, it is likely that all events in each cluster are semantically similar to one another (e.g., of the same or similar topics). Events in different clusters are likely to be less semantically similar to one another (or semantically dissimilar), and thus of different topics.

In some cases, human-readable and/or human-understandable names or labels may be given to the clusters. Such a label may be a single word or a short sequence of words that semantically describe or summarize the types of events that have been assigned to a cluster. In some embodiments, this can involve identifying the most frequent or semantically representative features in the cluster (e.g., by way of techniques such as feature importance or frequency analysis to extract the most prevalent keywords or phrases, topic modeling, sentiment modeling). For instance, a cluster of symptoms all relating to a user not being able to access a Wifi network may be labeled with the text “Wifi not working.”

5. Determination of Probabilistic Relationships between Clusters

After the cluster spaces and clusters therein are established, probabilistic relationships between clusters may be determined. This may involve identifying, for each cluster of events, which subsequent clusters of events are the most likely to follow. For example, given a symptom cluster, there may be a relatively limited set of investigatory step clusters in the training data that have led to a root cause cluster. In other words, given a particular symptom, there are one or more types of investigatory steps that are most likely to lead to root cause identification.

FIG. 8B illustrates such a mapping for a small number of clusters, one set of clusters for each of symptoms, investigatory steps, root causes, and resolutions. Symptom clusters 850 are each directed to a different type of symptom as determined through block 706. Investigatory steps clusters 852 are each directed to a different type of investigatory step as determined through block 706. Root cause clusters 854 are each directed to a different type of root cause as determined through block 706. Resolution clusters 856 are each directed to a different type of resolution as determined through block 706.

Given these clusters, the events within each can be parsed to determine the probabilities of paths through FIG. 8B. As shown, symptom cluster A (which contains events associated with the particular type of symptom) is only followed by the types of investigatory steps found in investigatory step clusters B and C. Likewise, investigatory step clusters B and C are only followed by the types of root causes found in root cause clusters D, E, F, and G. As noted, once the root cause is identified, a resolution is usually apparent. Thus, root cause clusters D, E, F, and G each lead to a relatively small number of possible resolutions. Accordingly, it is generally acceptable to be able to use the procedures herein to identify a root cause, as doing so will almost always also identify an appropriate resolution.

With respect to probabilities, consider the relationships between investigatory step clusters B and C and root cause clusters D, E, F, and G. Each of investigatory step clusters B and C has a certain likelihood (probability) of identifying a root cause of the associated symptom. For instance, investigatory steps in investigatory step cluster B leads to a root cause in root cause cluster D 30% of the time and to a root cause in root cause cluster F 60% of the time. The other 10% of the time, investigatory steps in investigatory step cluster B do not lead to a root cause. Likewise, investigatory steps in investigatory step cluster C lead to a root cause in root cause cluster E 10% of the time, to a root cause in root cause cluster F 20% of the time, and to a root cause in root cause cluster G 10% of the time. The other 60% of the time, investigatory steps in investigatory step cluster C do not lead to a root cause.

Given just this information, it is apparent that an investigatory step from investigatory step cluster B is more likely to lead to a root cause than an investigatory step from investigatory step cluster C. Alternatively, these probabilities may be conditioned on the symptom cluster. That is, given a symptom in symptom cluster A, there would be a 90% chance that an investigatory step from investigatory step cluster B leads to a root cause, which there would be a 40% chance that an investigatory step from investigatory step cluster C leads to a root cause. If the symptom is from a different cluster, these probabilities may be different (not shown in FIG. 8B).

These probabilities may be represented in the form of a directed acyclic graph between the various clusters, wherein the edges represent the probabilities of progressing from one cluster to another. But other graph representations are possible.

In any case, FIG. 8B is just a small example for purposes of illustration. The embodiments herein may include tens, hundreds, or more of each type of cluster interconnected in various complex manners. How these probabilistic relationships are used to recommend investigatory steps is discussed below.

### B. Prediction Phase

This subsection provides a detailed disclosure of the blocks associated with the prediction phase of FIG. 7B. Nonetheless, more or fewer blocks of the same or a different character may be used. This subsection also assumes that events have been identified from a corpus of incident logs, and that these events were used to generate probabilistic relationships between clusters of the events, such as those which are illustrated in FIG. 8B.

The blocks of FIG. 7B are typically carried out on data from a new incident log before its symptoms are resolved. In particular, when given a symptom, the block of FIG. 7B provides techniques for recommending particular investigatory steps that are most likely to lead to identification of a root cause. This recommendation may be provided to a human or virtual agent.

### 1. Preprocessing, Summarization, and Classification of a New Incident Log

As noted above, preprocessing can involve applying any type of normalization or outlier removal to a new incident log, including but not limited to removal of punctuation and/or stop words, stemming, lemmatization, word or phrase replacement, word or phrase deletion, and so on. The preprocessing that takes place as part of block 750 may be identical or similar to that of block 700.

Also as noted above, summarization can involve applying extractive or abstractive summarization, for example, to the preprocessed incident log. The summarization that takes place as part of block 750 may be identical or similar to that of block 702.

Again as noted above, classification can involve applying a trained classifier to the preprocessed and summarized new incident log. The trained classifier could be a naïve Bayes, support vector machine, decision tree, random forest, or neural network classifier. The classification that takes place as part of block 750 may be identical or similar to that of block 704. Since a goal of block 750 is to identify one or more symptoms from the incident log, only events classified as symptoms may be subject to the following steps.

### 2. Determination of Similar Symptoms

Determination of similar symptoms may involve taking one or more events classified as symptoms and applying the feature selection as discussed above. As noted, feature selection may involve projecting the text of the symptom into a multidimensional vector. Then, this vector can be compared to properties of the symptom clusters established during the training phase. For example, a Euclidian distance (straight-line distance between two points in n-space) or cosine similarity (the cosine of the angle between two vectors in n-space) between this vector and the centroid of each symptom cluster may be calculated. Then, the symptom from the new incident log may be considered to be a likely member of the closest symptom cluster (in terms of Euclidian distance) or most similar symptom cluster (in terms of cosine similarity). Other possibilities exist. For example, in some cases more than one closest symptom cluster may be identified.

### 3. Selection of Investigatory Step Cluster

With the symptom and a similar symptom cluster identified, an investigatory step cluster is then selected based on the likelihood that this investigatory step cluster will lead to a root cause. Since multiple investigatory step clusters may lead to a root cause for this symptom, this selection may be iterative in nature, as shown in blocks 754 and 756.

Considering FIG. 8B as an illustrative example, suppose that the new incident log is determined to contain a symptom that is similar to those of symptom cluster A. In this case, there are two possible investigatory step clusters to recommend, investigatory step cluster B and investigatory step cluster C. As noted above, one or both of these clusters may be recommended to a human or virtual agent based on their probability relationships to one or more of root cause clusters 854.

Various techniques may be used to determine the order in which to suggest these investigatory step clusters. For example, the investigatory step cluster with the highest probability of leading to a root cause (i.e., investigatory step cluster B) may be suggested first. This cluster may contain a label or associated text that describes one or more investigatory steps for the agent to take. If these steps identify a root cause of the symptom at block 756, then control passes to block 758. Otherwise, control returns to 754 where the investigatory step cluster with the next highest probability of leading to a root cause (i.e., investigatory step cluster C) may be suggested. This process continues until either a root cause is identified or no other investigatory step cluster remains untried. Other suggestion criteria may be the investigatory step cluster that is most likely to reduce the number of candidate root cause clusters.

In other words, the system (e.g., a remote network management platform) suggests a series of investigatory steps to an agent based on the trained models. The agent carries out each suggested investigatory step until root cause is determined or the system runs out of suggestions. In the latter case, the agent falls back on their subjective experience to address the incident log.

For example, if the symptom is “Wifi not working”, the first suggested investigatory step may be to identify the Wifi access point to which the user is attempting to connect, the second suggested investigatory step may be to identify to check that the user is using the proper Wifi password, and so on. In some cases, a dozen or more investigatory steps may be available for suggestion.

### 4. Application of the Resolution

Once the root cause is identified, the resolution is typically apparent, or at least the number of possible resolutions is likely to be low (e.g., 2 or 3 at most). If the agent is virtual, it may automatically carry out the resolution when it can (e.g., resetting a password, providing the user with needed information, rebooting a device, etc.). If the agent is human, they may carry out the resolution.

### VII. Example Operations

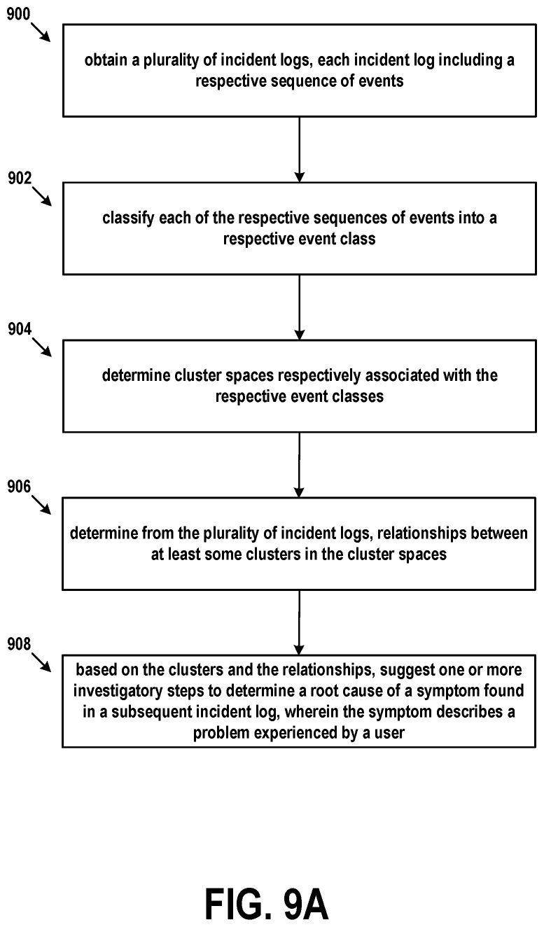

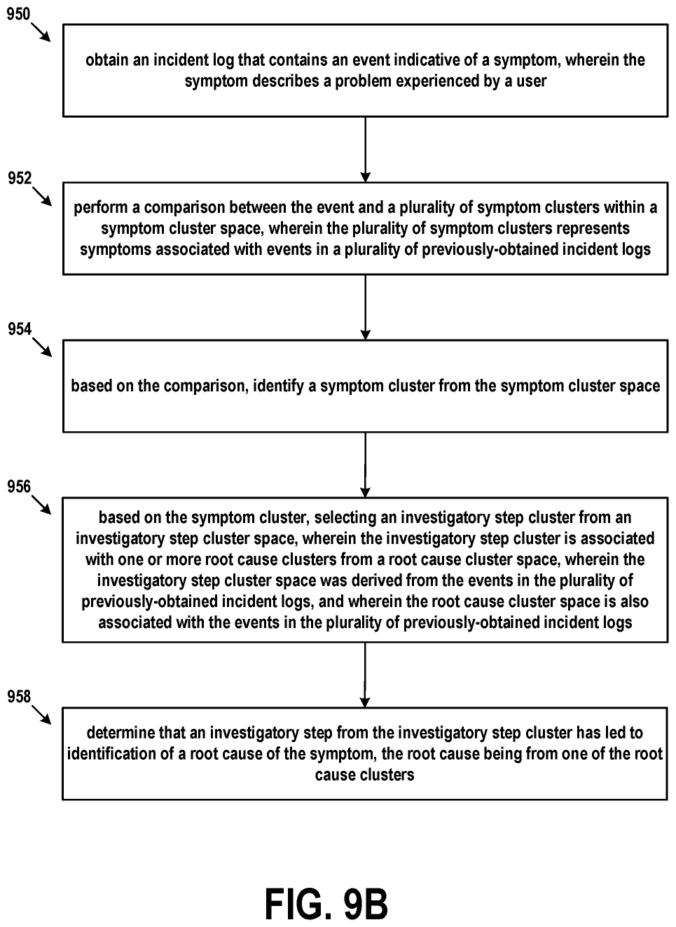

FIGS. 9A and 9B are flow charts illustrating example embodiments. The processes illustrated by FIGS. 9A and 9B may be carried out by a computing device, such as computing device 100, and/or a cluster of computing devices, such as server cluster 200. However, the processes can be carried out by other types of devices or device subsystems. For example, the processes could be carried out by a computational instance of a remote network management platform or a portable computer, such as a laptop or a tablet device.

The embodiments of FIGS. 9A and 9B may be simplified by the removal of any one or more of the features shown therein. Further, these embodiments may be combined with features, aspects, and/or implementations of one another and/or any of the previous figures or otherwise described herein.

In FIG. 9A, block 900 may involve obtaining a plurality of incident logs, each incident log including a respective sequence of events. Block 902 may involve classifying each of the respective sequences of events into a respective event class. Block 904 may involve determining cluster spaces respectively associated with the respective event classes. Block 906 may involve determining, from the plurality of incident logs, relationships between at least some clusters in the cluster spaces. Block 908 may involve, based on the clusters and the relationships, suggesting one or more investigatory steps to determine a root cause of a symptom found in a subsequent incident log, wherein the symptom describes a problem experienced by a user.

In some embodiments, the respective event classes include symptoms, investigatory steps, and root causes, wherein the symptoms describe problems experienced by users, the investigatory steps describe actions taken to determine the root causes of corresponding symptoms, and the root causes are primary reasons for observation of the corresponding symptoms.

In some embodiments, the respective event classes also include resolutions, wherein the resolutions describe actions that have been taken to rectify corresponding root causes.

In some embodiments, at least some of the incident logs include textual content, the embodiments further comprising: prior to classifying each of the respective sequence of events, performing one or more of stop word removal, form text removal, stemming, or lemmatization on the incident logs.

In some embodiments, at least some of the incident logs include textual content, the embodiments further comprising: prior to classifying each of the respective sequences of events, performing extractive summarization or abstractive summarization on the incident logs.

In some embodiments, classifying each of the respective sequence of events into the respective event class comprises: using a classifier that was pre-trained on a corpus of labelled events from incident logs, wherein labels of the labelled events indicate the respective event classes, and wherein the classifier has learned associations between content of the incident logs and the respective event classes.

In some embodiments, determining the cluster spaces respectively associated with the respective event classes comprises, for each of the respective event classes: projecting the events classified therein into multi-dimensional representations; and based on distances or angles between the multi-dimensional representations, forming the clusters in the cluster spaces.

In some embodiments, determining the relationships between at least some clusters in the cluster spaces comprises: based on the respective sequences of events, determining probabilistic likelihoods of events progressing from a first of two of the clusters to a second of the two of the clusters.

In some embodiments, determining the probabilistic likelihoods comprises constructing a directed acyclic graph of the clusters, wherein edges of the directed acyclic graph represent the probabilistic likelihoods.

Some embodiments further involve labelling each of the clusters based on semantic content of the events therein.

Some embodiments further involve, after determining the root cause of the symptom found in the subsequent incident log, causing a computing device to change its configuration, change one or more applications that it is executing, or reboot.

In FIG. 9B, block 950 may involve obtaining an incident log that contains an event indicative of a symptom, wherein the symptom describes a problem experienced by a user. Block 952 may involve performing a comparison between the event and a plurality of symptom clusters within a symptom cluster space, wherein the plurality of symptom clusters represents symptoms associated with events in a plurality of previously-obtained incident logs. Block 954 may involve, based on the comparison, identifying a symptom cluster from the symptom cluster space. Block 956 may involve, based on the symptom cluster, selecting an investigatory step cluster from an investigatory step cluster space, wherein the investigatory step cluster is associated with one or more root cause clusters from a root cause cluster space, wherein the investigatory step cluster space was derived from the events in the plurality of previously-obtained incident logs, and wherein the root cause cluster space is also associated with the events in the plurality of previously-obtained incident logs. Block 958 may involve determining that an investigatory step from the investigatory step cluster has led to identification of a root cause of the symptom, the root cause being from one of the root cause clusters.

In some embodiments, performing the comparison between the event and the plurality of symptom clusters comprises: determining similarity metrics between the event and each of the plurality of symptom clusters.

In some embodiments, identifying the symptom cluster from the symptom cluster space comprises: selecting the symptom cluster because it is most similar to the event with respect to the similarity metrics.

Some embodiments may further involve, prior to performing the comparison between the event and the plurality of symptom clusters, classifying the event into a symptom event class using a classifier that was pre-trained on a corpus of labelled events from incident logs, wherein labels of the labelled events indicate respective event classes, and wherein the classifier has learned associations between content of the labelled events in the incident logs and the respective event classes.

In some embodiments, the investigatory step cluster is selected because it has a highest probability, within the investigatory step cluster space, of leading to one of the root cause clusters.

In some embodiments, the investigatory step cluster is selected because it has a highest probability, within the investigatory step cluster space, of reducing a number of candidate root cause clusters.

Some embodiments may further involve, based the root cause, selecting a resolution cluster from a resolution cluster space, wherein the resolution cluster contains a resolution that describes actions that have been taken to rectify the root cause.

In some embodiments, the resolution involves causing a computing device to change its configuration, change one or more applications that it is executing, or reboot.

### VIII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining a plurality of incident logs, each incident log including a respective sequence of events;
classifying each of the respective sequences of events into a respective event class;
determining cluster spaces respectively associated with the respective event classes;
determining, from the plurality of incident logs, relationships between at least some clusters in the cluster spaces; and
based on the clusters and the relationships, suggesting one or more investigatory steps to determine a root cause of a symptom found in a subsequent incident log, wherein the symptom describes a problem experienced by a user.

2. The method of claim 1, wherein the respective event classes include symptoms, investigatory steps, and root causes, wherein the symptoms describe problems experienced by users, the investigatory steps describe actions taken to determine the root causes of corresponding symptoms, and the root causes are primary reasons for observation of the corresponding symptoms.

3. The method of claim 2, wherein the respective event classes also include resolutions, wherein the resolutions describe actions that have been taken to rectify corresponding root causes.

4. The method of claim 1, wherein at least some of the incident logs include textual content, the method further comprising:
prior to classifying each of the respective sequence of events, performing one or more of stop word removal, form text removal, stemming, or lemmatization on the incident logs.

5. The method of claim 1, wherein at least some of the incident logs include textual content, the method further comprising:
prior to classifying each of the respective sequences of events, performing extractive summarization or abstractive summarization on the incident logs.

6. The method of claim 1, wherein classifying each of the respective sequence of events into the respective event class comprises:
using a classifier that was pre-trained on a corpus of labelled events from incident logs, wherein labels of the labelled events indicate the respective event classes, and wherein the classifier has learned associations between content of the incident logs and the respective event classes.

7. The method of claim 1, wherein determining the cluster spaces respectively associated with the respective event classes comprises, for each of the respective event classes:
projecting the events classified therein into multi-dimensional representations; and
based on distances or angles between the multi-dimensional representations, forming the clusters in the cluster spaces.

8. The method of claim 1, wherein determining the relationships between at least some clusters in the cluster spaces comprises:
based on the respective sequences of events, determining probabilistic likelihoods of events progressing from a first of two of the clusters to a second of the two of the clusters.

9. The method of claim 8, wherein determining the probabilistic likelihoods comprises constructing a directed acyclic graph of the clusters, wherein edges of the directed acyclic graph represent the probabilistic likelihoods.

10. The method of claim 1, further comprising:
labelling each of the clusters based on semantic content of the events therein.

11. The method of claim 1, further comprising:
after determining the root cause of the symptom found in the subsequent incident log, causing a computing device to change its configuration, change one or more applications that it is executing, or reboot.

12. A method comprising:
obtaining an incident log that contains an event indicative of a symptom, wherein the symptom describes a problem experienced by a user;
performing a comparison between the event and a plurality of symptom clusters within a symptom cluster space, wherein the plurality of symptom clusters represents symptoms associated with events in a plurality of previously-obtained incident logs;
based on the comparison, identifying a symptom cluster from the symptom cluster space;
based on the symptom cluster, selecting an investigatory step cluster from an investigatory step cluster space, wherein the investigatory step cluster is associated with one or more root cause clusters from a root cause cluster space, wherein the investigatory step cluster space was derived from the events in the plurality of previously-obtained incident logs, and wherein the root cause cluster space is also associated with the events in the plurality of previously-obtained incident logs; and
determining that an investigatory step from the investigatory step cluster has led to identification of a root cause of the symptom, the root cause being from one of the root cause clusters.

13. The method of claim 12, wherein performing the comparison between the event and the plurality of symptom clusters comprises:
determining similarity metrics between the event and each of the plurality of symptom clusters.

14. The method of claim 13, wherein identifying the symptom cluster from the symptom cluster space comprises:
selecting the symptom cluster because it is most similar to the event with respect to the similarity metrics.

15. The method of claim 12, further comprising:
prior to performing the comparison between the event and the plurality of symptom clusters, classifying the event into a symptom event class using a classifier that was pre-trained on a corpus of labelled events from incident logs, wherein labels of the labelled events indicate respective event classes, and wherein the classifier has learned associations between content of the labelled events in the incident logs and the respective event classes.

16. The method of claim 12, wherein the investigatory step cluster is selected because it has a highest probability, within the investigatory step cluster space, of leading to one of the root cause clusters.

17. The method of claim 12, wherein the investigatory step cluster is selected because it has a highest probability, within the investigatory step cluster space, of reducing a number of candidate root cause clusters.

18. The method of claim 12, further comprising:
based the root cause, selecting a resolution cluster from a resolution cluster space, wherein the resolution cluster contains a resolution that describes actions that have been taken to rectify the root cause.

19. The method of claim 18, wherein the resolution involves causing a computing device to change its configuration, change one or more applications that it is executing, or reboot.

20. A non-transitory computer-readable medium, having stored thereon program instructions that, upon execution by a computing system, cause the computing system to perform operations comprising:
obtaining a plurality of incident logs, each incident log including a respective sequence of events;
classifying each of the respective sequences of events into a respective event class;
determining cluster spaces respectively associated with the respective event classes;
determining, from the plurality of incident logs, relationships between at least some clusters in the cluster spaces; and
based on the clusters and the relationships, suggesting one or more investigatory steps to determine a root cause of a symptom found in a subsequent incident log, wherein the symptom describes a problem experienced by a user.
